(19) United States
(12) Patent Application Publication
(10) Pub. No.: US 2024/0179597 A1
(43) Pub. Date: May 30, 2024

(54) ELECTRONIC DEVICE, WIRELESS COMMUNICATION METHOD, AND COMPUTER READABLE STORAGE MEDIUM

(71) Applicant: Sony Group Corporation, Tokyo (JP)

(72) Inventors: Xiaodong XU, Beijing (CN); Kun LI, Beijing (CN); Shiying YAN, Beijing (CN); Zhihan HUANG, Beijing (CN); Lu TIAN, Beijing (CN); Shumeng ZHANG, Beijing (CN); Haojin LI, Beijing (CN); Tao CUI, Beijing (CN)

(73) Assignee: Sony Group Corporation, Tokyo (JP)

(21) Appl. No.: 18/547,877

(22) PCT Filed: Feb. 23, 2022
(86) PCT No.: PCT/CN2022/077346

§ 371 Date: Aug. 25, 2023

(30) Foreign Application Priority Data
Mar. 1, 2021 (CN) 202110224696.6

(51) Int. Cl. H04W 36/22; H04W 28/02

(52) U.S. Cl. CPC H04W 36/22; H04W 28/0289

(57) ABSTRACT

An electronic device, a wireless communication method, and a computer readable storage medium are provided. The electronic device comprises a processing circuit configured to: determine whether uplink transmission of an IAB node satisfies a long-term congestion condition; when it is determined that the long-term congestion condition is satisfied, send an offloading request to an IAB donor node; and perform data offloading of an egress link of the uplink transmission of the IAB node according to offloading license information from the IAB donor node. According to at least one aspect of the embodiments of the present disclosure, when the uplink transmission of the IAB node satisfies the long-term congestion condition, the data offloading of the egress link of the uplink transmission of the IAB node can be performed, so as to improve the backhaul capability of the IAB node, thereby solving the long-term congestion problem of the IAB node.

The present application claims priority to Chinese Patent Application No. 202110224696.6, titled “ELECTRONIC DEVICE, WIRELESS COMMUNICATION METHOD, AND COMPUTER READABLE STORAGE MEDIUM”, filed on Mar. 1, 2021 with the China National Intellectual Property Administration, which is incorporated herein by reference in its entirety.

### FIELD

The present disclosure relates to the technical field of wireless communication, and in particular to an electronic device, a wireless communication method and a non-transitory computer-readable storage medium adapted to solve an uplink congestion problem of an integrated access and backhaul (IAB) (also referred to as access and backhaul integration) node.

### BACKGROUND

An IAB network has a multi-hop characteristic, and includes an IAB donor node and an IAB node. The IAB donor node establishes connection with a core network via a cable, and is configured to control the IAB network. Multiple deployed IAB nodes are configured to provide access service for a user equipment, and the user equipment is connected to the IAB network via an access link with the IAB node (an access point). Each IAB node may serve as a backhaul (BH) relay of other IAB node, so that each IAB node is connected to the IAB donor node via wireless backhaul in a single hop or multiple hops.

Congestion may occur to uplink transmission of the IAB node in the IAB network. Severe congestion will result in data packet loss, and a longer waiting time for the user, and thus resulting in degradation of the network characteristic. In the existing uplink congestion control scheme “Backpressure”, an upload rate of a sub node of a congested node and a user equipment thereof is limited to alleviate congestion. However, this scheme adapts to only a short term congestion problem of the IAB node.

Therefore, it is expected to provide a congestion solution, to solve the congestion problem of the IAB node, particularly the long term congestion problem.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

In view of the above problem, an electronic device, a wireless communication method and a non-transitory computer readable storage medium are provided according to an object of at least one aspect of the present disclosure, to solve the problem of long term congestion of uplink transmission of the IAB node.

According to an aspect of the present disclosure, an electronic device including processing circuitry is provided. The processing circuitry is configured to: determine whether uplink transmission of an integrated access and backhaul (IAB) node satisfies a long term congestion condition; send an offload request to an IAB donor node when it is determined that the long term congestion condition is satisfied; and perform data offloading on an egress link of the uplink transmission of the IAB node according to offload permission information from the IAB donor node.

According to another aspect of the present disclosure, an electronic device including processing circuitry is provided. The processing circuitry is configured to: receive an offload request from an integrated access and backhaul (IAB) node, where the offload request is sent when uplink transmission of the IAB node satisfies a long term congestion condition; determine, in response to the offload request, whether to permit the IAB node to perform data offloading on an egress link of the uplink transmission of the IAB node; and send offload permission information to the IAB node based on a result of the determining.

According to another aspect of the present disclosure, a wireless communication method is further provided. The method includes: determining whether uplink transmission of an integrated access and backhaul (IAB) node satisfies a long term congestion condition; sending an offload request to an IAB donor node when it is determined that the long term congestion condition is satisfied; and performing data offloading on an egress link of the uplink transmission of the IAB node according to offload permission information from the IAB donor node.

According to another aspect of the present disclosure, a wireless communication method is further provided. The method includes: receiving an offload request from an integrated access and backhaul (IAB) node, where the offload request is sent when uplink transmission of the IAB node satisfies a long term congestion condition; determining, in response to the offload request, whether to permit the IAB node to perform data offloading on an egress link of the uplink transmission of the IAB node; and sending offload permission information to the IAB node based on a result of the determining.

According to another aspect of the present disclosure, a non-transitory computer-readable storage medium storing executable instructions is further provided. When the executable instructions are executed by a processer, the processor is caused to perform functions of the electronic device or the wireless communication method described above.

According to other aspects of the present disclosure, a computer program code and a computer program product for implementing the wireless communication method according to the present disclosure are further provided.

According to at least one aspect of the embodiments of the present disclosure, when the uplink transmission of the IAB node satisfies the long term congestion condition, data offloading is performed on the egress link of the uplink transmission of the IAB node, thereby improving backhaul capability of the IAB node and solving the long term congestion problem of the IAB node.

Other aspects of the embodiments of the present disclosure are described hereinafter. Detailed description is used to thoroughly disclose preferred embodiments of the present disclosure and is not intended to limit the present disclosure.

### BRIEF DESCRIPTION OF THE DRAWINGS

Accompanying drawings are described herein to schematically illustrate selected embodiments rather than all possible embodiments, and are not intended to limit the scope of the present disclosure. In the accompanying drawings:

FIG. 1 is a schematic structural diagram of an IAB network;

FIG. 2 is a block diagram of a configuration example of an electronic device according to an embodiment of the present disclosure;

FIG. 3 is a schematic diagram of a first example of a long term congestion condition according to a first embodiment of the present disclosure;

FIG. 4 is a schematic diagram of a second example of the long term congestion condition according to the embodiment of the present disclosure;

FIG. 5 is a block diagram of a configuration example of an electronic device according to a second embodiment of the present disclosure;

FIG. 6 is a flowchart of an example of information interaction flow according to an embodiment of the present disclosure;

FIG. 7 is flowchart of an exemplary process of a wireless communication method according to the first embodiment of the present disclosure;

FIG. 8 is a flowchart of an exemplary process of the wireless communication method according to the second embodiment of the present disclosure;

FIG. 9 is a block diagram showing a first example of an exemplary configuration of an eNB to which the technology of the present disclosure may be applied; and

FIG. 10 is a block diagram showing a second example of an exemplary configuration of an eNB to which the technology of the present disclosure may be applied.

Although the present disclosure is easily subjected to various modifications and replacements, specific embodiments as examples are shown in the drawings and described in detail here. However, it should be understood that, the description of specific embodiments is not intended to limit the present disclosure. In contrast, the present disclosure is intended to cover all modifications, equivalents and replacements falling within the spirit and scope of the present disclosure. It should be noted that, corresponding reference numerals indicate corresponding components throughout several drawings.

### DETAILED DESCRIPTION OF EMBODIMENTS

Examples of the present disclosure are fully disclosed with reference to the drawings. The description below is only schematic in essence, and is not intended to limit the present disclosure, application or usage.

Schematic embodiments are provided, so that the present disclosure will become thorough and fully convey the scope thereof to those skilled in the art. Many specific details such as examples of specific components, devices and methods are clarified here, to provide detailed understanding of embodiments of the present disclosure. It is apparent for those skilled in the art that, the schematic embodiments may be implemented by many different ways without using specific details, which should not be understood as limiting the scope of the present disclosure. In some schematic examples, well-known processes, structures and technologies are not described in detail.

Description is made in the following order:
1. Summary
2. Configuration examples of a first embodiment
3. Configuration examples of a second embodiment
4. Examples of information interaction flow
5. Method embodiments
6. Application examples

### 1. SUMMARY

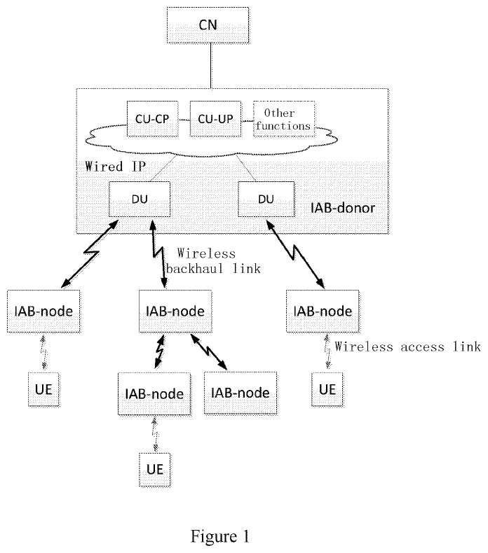

An architecture of an IAB network is described with reference to FIG. 1. As shown by FIG. 1, the IAB network includes an IAB donor node IAB-donor and an IAB node IAB-node. The IAB donor node IAB-donor is configured to establish connection with a core network CN via a cable, and is configured to control the IAB network. The IAB node IAB-node is configured to provide access service for a user equipment UE, and is connected to the IAB donor node via wireless backhaul in a single hop or multiple hops. In an architecture in which a center unit CU (including user plane, CU-UP, control plane CU-CP and other functions) is separated from a control unit DU, the IAB node is configured to provide an access and forward function, and may be connected to IAB network by establishing a backhaul connection with a superior node (a parent node). The IAB has great flexibility according to such a design.

In the multi-hop IAB network shown in FIG. 1, for a given IAB node, in a case that an ingress rate is greater than an egress rate for uplink transmission from a user equipment or an inferior node (a sub node), a load (a load amount) of the IAB node increases. The IAB node is in a congestion state when the load of the IAB node reaches a maximum value. In this case, data packet loss occurs for the IAB node, and time for waiting services becomes longer for a sub node or user equipment of a congested node.

Therefore, it is necessary to study a scheme for congestion control to alleviate congestion. In the conventional technology, the uplink congestion control scheme “Backpressure” is performed by UP. In which, an upload rate of the sub node or the user equipment of the sub node of the IAB node in the congestion state (referred to as a congestion node hereinafter) is limited, to avoid a case that the ingress rate is greater than the egress rate for the uplink transmission of the IAB node, thereby reducing the load of the congestion node.

The existing congestion solution is suitable to control short term congestion resulting from temporary traffic outbreak for example, that is, congestion due to traffic at the IAB node temporarily exceeding a service capability provided by the IAB node in a short time period. In the short term congestion case, according to the existing congestion solution, the ingress rate of the congestion node is limited to reduce the load of the congestion node, so that the congestion node can recover when the traffic outbreak ends.

However, in actual applications, long term congestion with a long duration may occur to the IAB node, which may result in failure of a wireless link. This is a serious result for the network and the user equipment. The long term congestion is caused by mismatch between a transmission capability of an ingress link and a transmission capability of an egress link for the IAB node (that is, the service capability of the IAB node cannot satisfy traffic requirements of the IAB node for long time). The mismatch may be caused by limited transmission capability of the egress link of the IAB node for long time (for example, the wireless backhaul link is congested), or may be caused by great traffic of the IAB node for long time. The long term congestion cannot be overcome fundamentally by limiting the ingress rate of the congestion node according to the existing congestion solution.

In view of the above problem, the inventor puts forward a concept of the present disclosure as follows. When uplink transmission of the IAB node satisfies the long term congestion condition, data offloading is performed on an egress link of the uplink transmission of the IAB node (that is, adjusting the egress link based on CP), to improve the transmission capability (that is, a backhaul capability) of the egress link of the IAB node, thereby solving the long term congestion problem of the IAB node.

### 2. CONFIGURATION EXAMPLES OF A FIRST EMBODIMENT

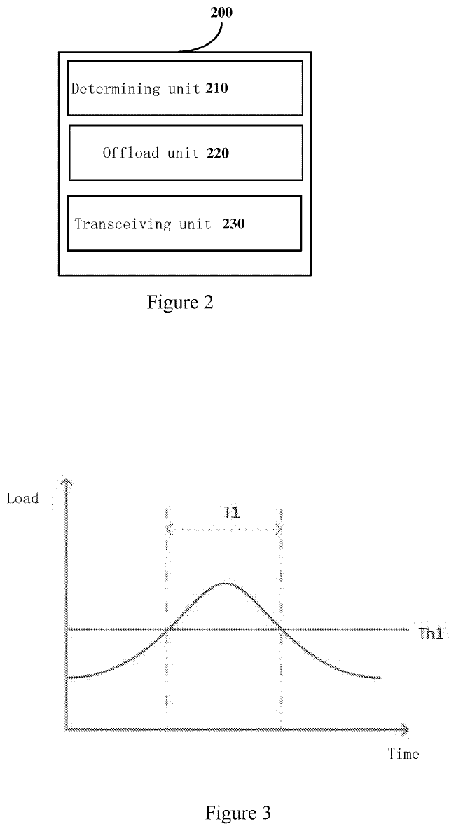

FIG. 2 is a block diagram of a first configuration example of an electronic device according to a first embodiment of the present disclosure.

As shown in FIG. 2, the electronic device 200 may include a determining unit 210, an offload unit 220 and a transceiving unit 230.

Here, units of the electronic device 200 may be included in a processing circuitry. It should be noted that, the electronic device 200 may include one or more processing circuitries. The processing circuitry may include various discrete functional units to perform different functions and/or operations. It should be noted that, the functional unit may be a physical entity or a logical entity, and units with different names may be implemented by the same physical entity.

In an example, the electronic device 200 shown in FIG. 2 may be applied to an IAB node side in the IAB network described with reference to FIG. 1. For example, the electronic device 200 may be the IAB node itself, or may be connected to the IAB node. For convenience of description, it is assumed that the electronic device 200 is the IAB node hereinafter.

According to the embodiment, the determining unit 210 of the electronic device 200 may determine whether uplink transmission of an integrated access and backhaul (IAB) node satisfies a long term congestion condition. The offload unit 220 may generate an offload request when it is determined that the long term congestion condition is satisfied, and send the offload request to an IAB donor node via the transceiving unit 230. When offload permission information from the IAB donor node is received via the transceiving unit 230, the offload unit 220 performs data offloading on the egress link of the uplink transmission of the IAB node.

With the electronic device according to the embodiment, for the IAB node in the uplink long term congestion, data offloading is performed on the egress link of the uplink transmission of the IAB node, thereby improving the transmission capability (that is, the backhaul capability) of the egress link, and thus solving the long term congestion problem of the IAB node.

In an example, the long term congestion condition used by the determining unit 210 may include: a duration in which a first congestion standard is satisfied is greater than or equal to a first predetermined time period; or the number of times for which a second congestion standard is satisfied in a second predetermined time period is greater than or equal to a predetermined number of times, where the second congestion standard indicates more severe congestion than the first congestion standard.

Here, each congestion standard may be related to a load condition and/or a link quality of the egress link of the uplink transmission of the IAB node. In an example, a first congestion standard related to the load condition may be that the load of the uplink transmission of the IAB node exceeds a first load threshold, and a second congestion standard may be that the load exceeds a second load threshold greater than the first load threshold. The second load threshold may be set as a maximum load value actually resulting in congestion of the IAB node, for example (for example a congestion threshold triggering short term congestion control in the conventional technology). The determining unit 210 may obtain a load of a buffering region of the IAB node, and determine whether the first congestion standard and the second congestion standard are satisfied by comparing the load with the first and second load thresholds, thereby determining whether the long term congestion condition is satisfied.

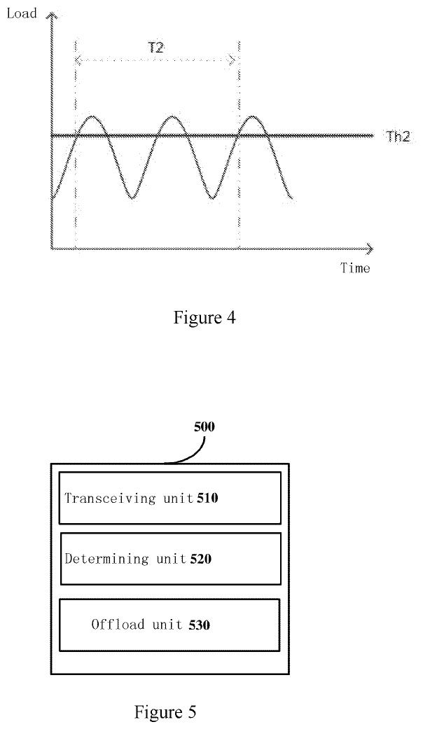

FIG. 3 and FIG. 4 are diagrams illustrating examples of the long term congestion condition according to embodiments of the present disclosure. FIG. 3 shows a first example of the long term congestion condition. The condition may be that a duration in which the load of the uplink transmission of the IAB node exceeds a first load threshold Th1 reaches a first predetermined time period T1. The load threshold Th1 may be set to be slightly less than a maximum load actually resulting in congestion of the IAB node. If the duration in which the load of the IAB exceeds the load threshold Th1 reaches the predetermined time period T1, it is indicated that the load is always at a higher level. In this case, although congestion does not occur, the load of the IAB node already exceeds the bearing capability of the node, and thus it is necessary to trigger long term congestion control.

FIG. 4 shows a second example of the long term congestion condition. The condition may be that the number of times for which the load of the uplink transmission of the IAB node exceeds a second load threshold Th2 in a second predetermined time period T2 reaches a predetermined number of times (2 in this example). The load threshold Th2 may be set to be equal to the maximum load actually resulting in congestion of the IAB node (for example, a congestion threshold triggering short term congestion control in the conventional technology). If the load of the IAB node exceeds the congestion threshold for multiple times in the predetermined time period, it is indicated that congestion which cannot be solved by the general congestion control method in the conventional technology occurs to the node.

According to the conventional technology, the congestion control method is generally started once the load of the IAB node reaches the congestion threshold (the maximum load actually resulting in the congestion of the IAB node), to limit the ingress rate of the IAB node until the load recovers to a normal level. If long term congestion occurs to the IAB node and the transmission capability of the egress link cannot satisfy the node service requirement, the load increases to the congestion threshold when the ingress rate limitation of the node is released with the existing congestion control method, resulting in triggering of congestion control again. In this case, the ingress link of the IAB node is in a continuous rate limited state, the throughput of the node significantly decreases, and thus a probability that congestion occurs to sub nodes greatly increases. The second example of the long term congestion condition shown in FIG. 4 particularly adapts to the above case, thereby avoiding potential long term congestion.

The first congestion standard related to the link quality of the egress link may be that the link quality of the egress link of uplink transmission of the IAB node is less than a first quality threshold, and the second congestion standard may be that the link quality is less than a second quality threshold lower than the first load threshold. The second quality threshold may represent that a link quality is slightly superior than a link quality resulting in failure of the wireless link, for example. The determining unit 210 may, for example, send a reference signal to a parent node of the IAB node periodically via the transceiving unit 230 and obtain a reference signal receiving power at the parent node (for example, receiving, from the parent node, a reference signal receiving power obtained by measuring the reference signal by the parent node), to determine the link quality of the egress link of the uplink transmission of the IAB node.

Based on the congestion standard related to the link quality, a third example of the long term congestion condition may be that a duration in which the link quality of the egress link of the IAB node is lower than the first quality threshold reaches a first predetermined time period, and a fourth example of the long term congestion condition may be that the number of times for which the link quality of the egress link of the IAB node is lower than the second quality threshold (lower than the first quality threshold) in a second predetermined time period reaches a predetermined number of times. The second quality threshold may, for example, represent that the link quality is slightly superior than the link quality resulting in failure of the wireless link. The above two examples of the long term congestion condition each represent that the link quality of the egress link of the IAB node is poor in a certain time period, that is, the transmission capability of the egress link of the node is limited continuously or intermittently. In this case, congestion occurs to the IAB node with a great probability, and identifying the above case and performing data offloading for the above case is beneficial to avoid potential long term congestion. Thresholds and time periods in the first to fourth examples may be set appropriately depending on system configurations and application requirements, and details are not repeated herein.

When the determining unit 210 determines that the uplink transmission of the IAB node satisfies the long term congestion condition, the offload unit 220 may generate an offload request, and send the offload request to the IAB donor node via the transceiving unit 230. In an example, the offload request may be packaged in BAP signaling, and forwarded to the IAB donor node via the parent node of the IAB node.

In an example, the IAB node may support dual connectivity and have a first parent node (referred to as a main parent node) and a second parent node. This means that the IAB node has two transmission paths. In the conventional technology, the IAB node generally performs data transmission through only a main transmission path via the first parent node, and performs data transmission through an auxiliary transmission path via the second parent node only when wireless link failure occurs in the main transmission path.

According to an example of the embodiment of the present disclosure, the auxiliary transmission path not used in the general case is used to perform data offloading. Specifically, the data offloading of the IAB node may include transmitting data of the uplink transmission of the IAB node through the main transmission path via the first parent node (including an access link from the IAB node to the first parent node and a backhaul link of the first parent node itself) and the auxiliary transmission path via the second parent node (including an access link from the IAB node to the second parent node and a backhaul link of the second parent node itself). In this way, the data of the uplink transmission of the IAB node is offloaded from the main transmission path to the auxiliary transmission path, thereby improving the backhaul capability of the node and being beneficial to alleviate the long term congestion of the IAB node.

In this example, preferably, the offload request generated by the offload unit 220 may include information for indicating a transmission rate at which the IAB node expects to perform uplink transmission through the auxiliary transmission path (expected transmission rate). The IAB donor node may determine a second parent node of the IAB node in response to the received offload request according to network topology, and obtain path condition information of the auxiliary transmission path via the second parent node, to determine whether to permit data offloading of the IAB node. In addition, offload permission information may be sent to the IAB node via the first parent node of the IAB node. In an example, the offload permission information may be information of 1 bit, where 1 represents permitting data offloading, and 0 represents not permitting data offloading. In addition, when it is determined to permit data offloading of the IAB node, the IAB donor node may provide offload configuration information for the IAB node (and optionally for the first parent node and the second parent node), and the offload configuration information may be sent to the IAB node via the first parent node of the IAB node.

When the electronic device 200 receives offload permission information indicating permitting to perform data offloading, the offload unit 220 may perform data offloading on the egress link of the uplink transmission of the IAB node according to offload configuration information from the IAB donor node.

In an example, the offload configuration information includes one or more of: offload ratio information, offload rate information and offload data amount information. The offload ratio information is used for indicating a ratio between a data amount of uplink transmission performed by the IAB node through the main transmission path and a data amount of uplink transmission performed by the IAB node through the auxiliary transmission path. The offload rate information is used for indicating a maximum transmission rate at which the IAB node performs uplink transmission through the auxiliary transmission path. The offload data amount information is used for indicating a maximum transmission data amount of uplink transmission performed by the IAB node through the auxiliary transmission path.

The offload unit 220 may perform data offloading based on offload configuration information. For example, the offload unit 220 may set a ratio between a data amount of the uplink transmission of the main transmission path and a data amount of the uplink transmission of the auxiliary transmission path for the IAB node, as a ratio indicated by the offload ratio information; set the uplink transmission rate of the auxiliary transmission path for the IAB node to be not exceeding the maximum transmission rate indicated by the offload rate information; and/or set a total data amount of the uplink transmission of the auxiliary transmission path for the IAB node to be not exceeding a maximum data amount indicated by the offload data amount information, and so on.

### 3. CONFIGURATION EXAMPLES OF A SECOND EMBODIMENT

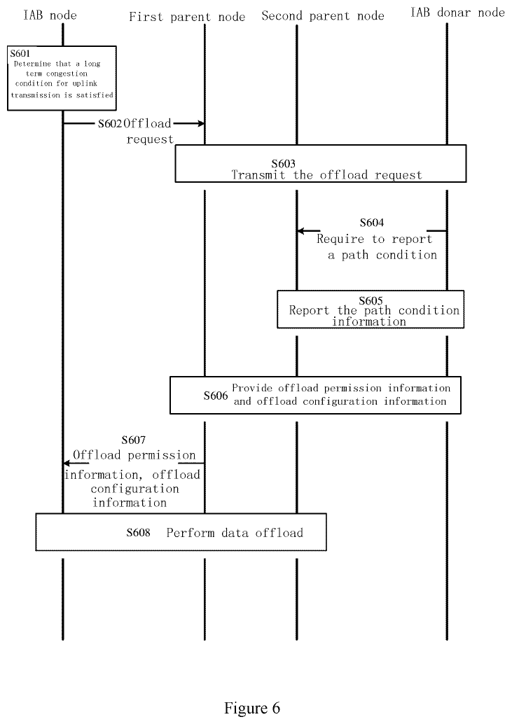

FIG. 5 is a block diagram of a first configuration example of an electronic device according to a second embodiment of the present disclosure.

As shown in FIG. 5, the electronic device 500 may include a transceiving unit 510, a determining unit 520 and an offload unit 530.

Here, units of the electronic device 500 may be included in a processing circuitry. It should be noted that, the electronic device 500 may include one or more processing circuitries. The processing circuitry may include various discrete functional units to perform different functions and/or operations. It should be noted that, the functional unit may be a physical entity or a logical entity, and units with different names may be implemented by the same physical entity.

In an example, the electronic device 500 shown in FIG. 5 may be applied to an IAB donor node side in the IAB network described with reference to FIG. 1. For example, the electronic device 500 may be the IAB donor node itself, or may be connected to the IAB donor node. For convenience of description, it is assumed that the electronic device 500 is the IAB donor node hereinafter.

According to the embodiment, the determining unit 510 of the electronic device 500 may receive an offload request from an integrated access and backhaul (IAB) node. The offload request is sent when uplink transmission of the IAB node satisfies a long term congestion condition. The determining unit 520 may determine whether to permit the IAB node to perform data offloading on an egress link of uplink transmission, in response to the offload request. The offload unit 530 may generate offload permission information and send the offload permission information to the IAB node via the transceiving unit 510, when the determining unit 520 determines to permit to perform data offloading, so that the IAB node can perform data offloading.

With the electronic device according to the embodiment, for the IAB node in the uplink long term congestion, data offloading is permitted on the egress link of the uplink transmission of the IAB node, thereby improving the transmission capability (that is, the backhaul capability) of the egress link, and thus solving the long term congestion problem of the IAB node.

The offload request received by the electronic device 500 is sent when long term congestion occurs for the uplink transmission of the IAB node. In an example, the offload request may be packaged in BAP signaling, and forwarded to the electronic device 500 as the IAB donor node via a parent node of the IAB node. In an example, the long term congestion condition of the uplink transmission of the IAB node that results in the sending of the offload request may include: a duration in which a first congestion standard is satisfied is greater than or equal to a first predetermined time period; and/or the number of times for which a second congestion standard is satisfied in a second predetermined timer period is greater than or equal to a predetermined number of times, where the second congestion standard indicates more severe congestion than the first congestion standard.

Here, each congestion standard may be related to a load condition and/or a link quality of the egress link of the uplink transmission of the IAB node. In an example, a first congestion standard related to the load condition may be that the load of the uplink transmission of the IAB node exceeds a first load threshold, and a second congestion standard may be the load exceeds a second load threshold greater than the first load threshold. The second load threshold may be set as a maximum load actually resulting in congestion of the IAB node, for example (for example a congestion threshold triggering short term congestion control in the conventional technology). The first congestion standard related to the link quality of the egress link may be that the link quality of the egress link of the uplink transmission of the IAB node is lower than a first quality threshold, and the second congestion standard may be that the link quality is lower than a second quality threshold less than the first quality threshold. The second quality threshold, for example, may represent a link quality slightly superior than a link quality resulting in wireless link failure. The long term congestion condition based on these congestion standards may include various examples of the long term congestion condition described in the first embodiment, for example.

In an example, the IAB node may support dual connectivity, and have a first parent node (referred to as a main parent node) and a second parent node. This means that the IAB node has two transmission paths. In the conventional technology, the IAB node generally performs data transmission through only a main transmission path via the first parent node, and performs data transmission through an auxiliary transmission path via the second parent node only when wireless link failure occurs in the main transmission path.

According to an example of the embodiment of the present disclosure, the auxiliary transmission path not used in the general case is used to perform data offloading. Specifically, the data offloading of the IAB node may include transmitting the data of the uplink transmission of the IAB node through the main transmission path via the first parent node and the auxiliary transmission path via the second parent node. In this way, the data of the uplink transmission of the IAB node is offloaded from the main transmission path to the auxiliary transmission path, thereby improving the backhaul capability of the node and thus being beneficial to alleviate the long term congestion of the IAB node.

The determining unit 520 of the electronic device 500 may determine, in response to the offload request from the IAB node, a second parent node of the IAB node according to network topology of the IAB network, and obtain path condition information of the auxiliary transmission path via the second parent node of the IAB node, to determine whether to permit data offloading of the IAB node.

In an example, the path condition information obtained from the second parent node may indicate the load condition of the second parent node and/or a link quality of the access link from the IAB node to the second parent node. In order to obtain such path condition information, the determining unit 520 may send an instruction to report the path condition information to the second parent node via the transceiving unit 510, so that the second parent node determines its load condition and measures a link quality of the access link from the IAB node to the second parent node, for example, to provide related information. In an example, the second parent node may determine the link quality of the access link from the IAB node to the second parent node by measuring a reference signal receiving power of a reference signal from the IAB node. Optionally, the path condition information obtained from the second parent node may further indicate a transmission rate of the ingress link, a transmission rate of the egress link and the supported maximum backhaul rate and so on for the uplink transmission of the second parent node.

The determining unit 520 may determine whether to permit data offloading of the IAB node based on the path condition information obtained from the second parent node. For example, the determining unit 520 may determine to permit data offloading of the IAB node, in a case that the path condition information indicates that long term congestion is unable to occur or the link quality is high for the second parent node. For example, the determining unit 520 may determine to permit data offloading of the IAB node, in a case that neither the load condition nor the link quality of the access link from the IAB node to the second parent node indicated by the path condition information satisfies the long term congestion condition.

In an example, the offload request received from the IAB node by the electronic device 500 may include information for indicating a transmission rate at which the IAB node expects to perform uplink transmission through the auxiliary transmission path (expected transmission rate). In this case, the determining unit 520 may determine whether to permit data offloading of the IAB node based on the path condition information of the second parent node of the IAB node and the expected transmission rate of the IAB node indicated by the offload request. For example, the determining unit 520 may determine to permit the data offloading of the IAB node, only when it is determined that the long term congestion is unable to occur to the second parent node according to the path condition information and the second parent node can provide the expected transmission rate of the IAB node (for example, a difference between the maximum backhaul rate supported by the second parent node and the transmission rate of the ingress link of the uplink transmission of the second parent node is greater than the expected transmission rate).

The offload unit 530 of the electronic device 500 may generate offload permission information based on a result of the determining of the determining unit 520, and send the offload permission information to the IAB node by the transceiving unit 510 via the first parent node of the IAB node. In an example, the offload permission information may be information of 1 bit, where 1 indicates permitting data offloading, and 0 indicating not permitting data offloading. Optionally, the electronic device 500 may send the offload permission information to the first parent node and the second parent node of the IAB node.

In addition, the electronic device 500 may provide offload configuration information to the IAB node when determining to permit data offloading of the IAB node. The offload configuration information may be sent to the IAB node via the first patent of the IAB node. Optionally, the offload configuration information may be provided to the second parent node of the IAB node.

When the IAB node receives offload permission information indicating permitting data offloading and the offload configuration information from the electronic device 500 serving as the IAB donor node, the IAB node performs the data offloading on the egress link of uplink transmission of the IAB node based on the offload configuration information.

In an example, the offload configuration information provided by the offload unit 530 includes one or more of: offload ratio information, offload rate information and offload data amount information. The offload ratio information is used for indicating a ratio between a data amount of uplink transmission performed by the IAB node through the main transmission path and a data amount of uplink transmission performed by the IAB node through the auxiliary transmission path. The offload rate information is used for indicating a maximum transmission rate at which the IAB node performs uplink transmission through the auxiliary transmission path. The offload data amount information is used for indicating a maximum data amount of uplink transmission performed by the IAB node through the auxiliary transmission path.

The offload unit 530 may generate the offload configuration information in an appropriate manner according to the path condition information of the second parent node and optionally based on the expected transmission rate of the IAB node indicated by the offload request. For example, the offload unit 530 may determine a difference between the maximum backhaul rate supported by the second parent node and the transmission rate of the ingress link of the uplink transmission of the second parent node, determine the maximum transmission rate of the uplink transmission performed by the IAB node through the auxiliary transmission path to be a transmission rate less than the difference, and generates offload rate information indicating the maximum transmission rate.

In addition, the offload unit 530 may determine a difference between the maximum backhaul rate supported by the second parent node (or the transmission rate of the egress link of uplink transmission of the second parent node) and the transmission rate of the ingress link of the uplink transmission of the second parent node, and determine, according to a ratio between that difference and the expected transmission rate of the IAB node indicated by the offload request, a ratio between a data amount of the uplink transmission performed through the main transmission path and a data amount of the uplink transmission performed through the auxiliary transmission path for the IAB node (for example, the larger the former ratio is, the smaller the latter ratio is), and generate offload ratio information indicating the ratio.

In addition, the offload unit 530 may determine a data amount of the uplink transmission which can be additionally supported by the second parent node in a certain time period, according the load of the second parent node and a difference between the maximum backhaul rate supported by the second parent node (or the transmission rate of the egress link of the uplink transmission of the second parent node) and the transmission rate of the ingress link of the uplink transmission of the second parent node, determine the maximum data amount of the uplink transmission performed by the IAB node through the auxiliary transmission path to be less than the additionally supported data amount, and generate offload data amount information indicating the maximum data amount.

### 4. EXAMPLES OF INFORMATION INTERACTION FLOW

FIG. 6 is a flowchart of an example of information interaction flow according to an embodiment of the present disclosure.

In the example, information interaction between an IAB node in a congestion state, a first parent node and a second parent node of the IAB node, and an IAB donor node is shown. The IAB node has, for example, functions of the electronic device 200 described with reference to FIG. 2, and the IAB donor node has, for example, functions of the electronic device 500 described with reference to FIG. 5.

As shown in FIG. 6, in step S601, the IAB node determines that uplink transmission of the IAB node satisfies a long term congestion condition, and in step S602, the IAB node sends an offload request to a first parent node of the IAB node. Optionally, the offload request may include information for indicating a transmission rate at which the IAB node expects to perform uplink transmission through an auxiliary transmission path (expected transmission rate). In step S603, the first parent node forwards the offload request to the IAB donor node.

In step S604, the IAB donor node sends an instruction to report path condition information to a second parent node. In step S605, the second parent node reports the path condition information of the second parent node to the IAB donor node. The path condition information indicates a path condition of an auxiliary transmission path of the IAB node via the second parent node.

In step S606, the IAB donor node determines to permit the IAB node to perform data offloading according to the path condition information of the second parent node and optionally according to the expected transmission rate indicated by the offload request, and provides offload permission information indicating permitting offload and the offload configuration information to the first parent node and the second parent node.

In step S607, the first parent node sends the offload permission information and the offload configuration information to the IAB node.

In step S608, the IAB node performs data offloading based on the offload permission information and the offload configuration information, to perform uplink transmission through a main transmission path via the first parent node and an auxiliary transmission path via the second parent node simultaneously.

In the example show in FIG. 6, a case that the IAB donor node determines to permit to perform data offloading is shown. Alternatively, when the IAB donor node determines not to permit to perform data offloading, the IAB donor node provides only offload permission information indicating not permitting offload in step S606, and the IAB node does not perform step S608.

### 5. METHOD EMBODIMENTS

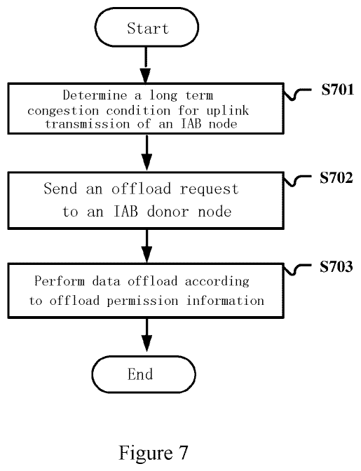

FIG. 7 is a flowchart of an example of a wireless communication method according to the first embodiment of the present disclosure. The method shown in FIG. 7 may, for example, be performed by the electronic device 200 described with reference to FIG. 2.

As shown in FIG. 7, in step S701, it is determined whether uplink transmission of an integrated access and backhaul (IAB) node satisfies a long term congestion condition. Then, when it is determined that the long term congestion condition is satisfied, an offload request is sent to an IAB donor node in step S702. In step S703, data offloading is performed on an egress link of uplink transmission of the IAB node, according to offload permission information from the IAB donor node.

In an example, the long term congestion condition includes: a duration in which a first congestion standard is satisfied is greater than or equal to a first predetermined time period; or the number of times for which a second congestion standard is satisfied in a second predetermined time period is greater than or equal to a predetermined number of times, where the second congestion standard indicates more severe congestion than the first congestion standard.

For example, the first congestion standard and/or the second congestion standard is related to a load condition and/or a link quality of the egress link of the uplink transmission of the IAB node.

Optionally, the IAB node supports dual connectivity, and has a first parent node and a second parent node. The data offloading includes transmitting data of the uplink transmission of the IAB node through a main transmission path via the first parent node and an auxiliary transmission path via the second parent node.

Optionally, the offload request includes information for indicating a transmission rate at which the IAB node expects to perform uplink transmission through the auxiliary transmission path.

Optionally, in step S703, the data offloading is performed according to the offload configuration information from the IAB donor node.

For example, the offload configuration information includes one or more of: offload ratio information, offload rate information and offload data amount information. The offload ratio information is used for indicating a ratio between a data amount of uplink transmission performed by the IAB node through the main transmission path and a data amount of uplink transmission performed by the IAB node through the auxiliary transmission path. The offload rate information is used for indicating a maximum transmission rate at which the IAB node performs uplink transmission through the auxiliary transmission path. The offload data amount information is used for indicating a maximum transmission data amount of uplink transmission performed by the IAB node through the auxiliary transmission path.

According to the embodiment of the present disclosure, the above method may be performed by the electronic device 200 described in the first embodiment of the present disclosure. Therefore, various aspects of the embodiments of the electronic device 200 adapt to the method embodiment.

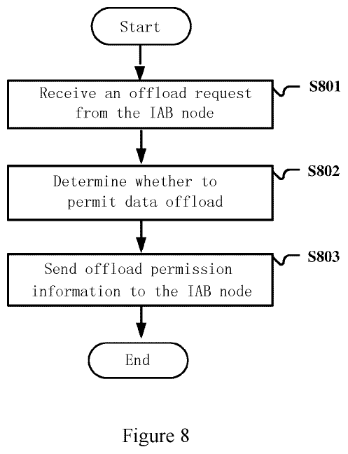

FIG. 8 is a flowchart of an example of the wireless communication method according to the second embodiment of the present disclosure. The method shown by FIG. 8 may be performed by the electronic device 500 described with reference to FIG. 5.

As shown in FIG. 8, in step S801, an offload request from an integrated access and backhaul (IAB) node is received. The offload request is sent when uplink transmission of the IAB node satisfies a long term congestion condition. Then, in step S802, in response to the offload request, it is determined whether to permit the IAB node to perform data offloading on an egress link of uplink transmission. In step S803, based on a result of the determining, offload permission information is sent to the IAB node.

In an example, the long term congestion condition of the uplink transmission of the IAB node includes: a duration in which a first congestion standard is satisfied is greater than or equal to a first predetermined time period; or the number of times for which a second congestion standard is satisfied in a second predetermined timer period is greater than or equal to a predetermined number of times, where the second congestion standard indicates more severe congestion than the first congestion standard.

For example, the first congestion standard and/or the second congestion standard is related to a load condition and/or a link quality of the egress link of the uplink transmission of the IAB node.

Optionally, the IAB node supports dual connectivity, and has a first parent node and a second parent node. The data offloading includes transmitting data of the uplink transmission of the IAB node through a main transmission path via the first parent node and an auxiliary transmission path via the second parent node.

Optionally, the offload request includes information for indicating a transmission rate at which the IAB node expects to perform uplink transmission through the auxiliary transmission path.

Optionally, before step S802, the method may include the following additional step: in response to the offload request, obtaining path condition information of the auxiliary transmission path from the second parent node. In an example, the path condition information may indicate a load of the second parent node and/or a link quality of an access link from the IAB node to the second parent node.

Optionally, in step S802, it is determined whether to permit the data offloading based on the path condition information. When it is determined to permit the data offloading, offload configuration information is provided for the IAB node in step S803.

For example, the offload configuration information includes one or more of: offload ratio information, offload rate information and offload data amount information. The offload ratio information is used for indicating a ratio between a data amount of uplink transmission performed by the IAB node through the main transmission path and a data amount of uplink transmission performed by the IAB node through the auxiliary transmission path. The offload rate information is used for indicating a maximum transmission rate at which the IAB node performs uplink transmission through the auxiliary transmission path. The offload data amount information is used for indicating a maximum transmission data amount of uplink transmission performed by the IAB node through the auxiliary transmission path.

According to the embodiment of the present disclosure, the above method may be performed by the electronic device 500 described in the second embodiment of the present disclosure. Therefore, various aspects of the embodiments of the electronic device 500 adapt to the method embodiment.

### 6. APPLICATION EXAMPLES

The technology according to the present disclosure may be applied to various products.

For example, the electronic devices 200, 500 may be implemented as any type of base station device, such as a macro eNB and a small eNB, or may be implemented as any type of gNB (a base station in a 5G system). The small eNB may be an eNB covering a cell smaller than a macro cell, such as a pico eNB, a micro eNB and a home (femto) eNB. Alternatively, the base station may be implemented as any other type of base station, such as NodeB and a base station transceiver station (BTS). The base station may include: a body configured to control wireless communication (also referred to as a base station device); and one or more remote radio head end (RRH) located at a place different from the body.

The electronic devices 200, 500 may be implemented as any type of TRP. The TRP may have a sending and receiving function. For example, the TRP may receive information from the user equipment and the base station device, and may send information to the user equipment and the base station device. In a typical example, the TRP may provide service for the user equipment, and is under control of the base station device. Further, the TRP may have a structure similar to the base station device, or may have only a structure related to information sending and receiving in the base station device.

### First Application Example

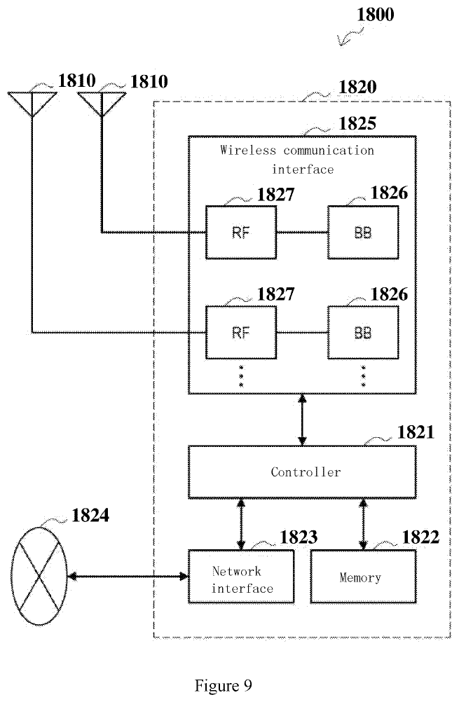

FIG. 9 is a block diagram showing a first example of a schematic configuration of an eNB to which the technology of the present disclosure may be applied. An eNB 1800 includes one or a more antennas 1810 and a base station device 1820. The base station device 1820 and each of the antennas 1810 may be connected with each other via an RF cable.

Each of the antennas 1810 includes one or more antenna elements (such as multiple antenna elements included in a multiple-input multiple-output (MIMO) antenna), and is used for transmitting and receiving a radio signal by the base station device 1820. The eNB 1800 may include the multiple antennas 1810, as shown in FIG. 9. For example, the multiple antennas 1810 may be compatible with multiple frequency bands used by the eNB 1800. Although FIG. 9 illustrates an example in which the eNB 1800 includes multiple antennas 1810, the eNB 1800 may also include a single antenna 1810.

The base station device 1820 includes a controller 1821, a memory 1822, a network interface 1823, and a wireless communication interface 1825.

The controller 1821 may be a CPU or a DSP and control various functions of higher layers of the base station device 1820. For example, the controller 1821 generates a data packet based on data in a signal processed by the wireless communication interface 1825, and transfers the generated packet via a network interface 1823. The controller 821 may bundle data from multiple baseband processors to generate bundled packet, and transfer the generated bundled packet. The controller 1821 may have logical functions of performing control such as radio resource control, radio bearer control, mobility management, admission control, and scheduling. The control may be performed in conjunction with an adjacent eNB or a core network node. The memory 1822 includes RAM and ROM, and stores a program that is executed by the controller 1821, and various types of control data (such as a terminal list, transmission power data, and scheduling data).

The network interface 1823 is a communication interface for connecting the base station device 1820 to a core network 1824. The controller 1821 may communicate with a core network node or another eNB via the network interface 1823. In this case, the eNB 1800 and the core network node or the other eNB may be connected to each other through a logical interface (such as an SI interface and an X2 interface). The network interface 1823 may also be a wired communication interface or a wireless communication interface for radio backhaul. If the network interface 1823 is a wireless communication interface, it may use a higher frequency band for wireless communication than a frequency band used by the wireless communication interface 1825.

The wireless communication interface 1825 supports any cellular communication scheme (such as Long Term Evolution (LTE) and LTE-Advanced), and provides wireless connection to a terminal positioned in a cell of the eNB 1800 via the antenna 1810. The wireless communication interface 1825 may typically include, for example, a base band (BB) processor 1826 and an RF circuit 1827. The BB processor 1826 may perform, for example, coding/decoding, modulation/demodulation and multiplexing/de-multiplexing, and perform various types of signal processing of the layers (for example L1, media access control (MAC), radio link control (RLC) and packet data convergence protocol (PDCP)). Instead of the controller 1821, the BB processor 1826 may have a part or all of the above-described logical functions. The BB processor 1826 may be a memory that stores the communication control program, or a module that includes a processor and related circuitry configured to perform the program. The function of the BB processor 1826 may be changed when the programs are updated. The module may be a card or a blade that is inserted into a slot of the base station device 1820. Alternatively, the module may be a chip that is mounted on the card or the blade. Meanwhile, the RF circuit 1827 may include, for example, a frequency mixer, a filter and an amplifier, and transmit and receive a radio signal via the antenna 1810.

As shown in FIG. 9, the wireless communication interface 1825 may include multiple BB processors 1826. For example, multiple BB processors 1826 may be compatible with multiple frequency bands used by the eNB 1800. As shown in FIG. 9, the wireless communication interface 1825 may include multiple RF circuits 1827. For example, the multiple RF circuits 1827 may be compatible with multiple antenna elements. Although an example in which the wireless communication interface 1825 includes multiple BB processors 1826 and multiple RF circuits 1827 is shown in FIG. 9, the wireless communication interface 1825 may also include a single BB processor 1826 or a single RF circuit 1827.

In the eNB 1800 shown in FIG. 9, the transceiving unit 230 of the electronic device 200 described with reference to FIG. 2 may be implemented by a wireless communication interface 1825 (optionally, together with an antenna 1810). The determining unit 210 and the offload unit 220 of the electronic device 200 may be implemented by the controller 1821 (optionally, together with the wireless communication interface 1825 and the antenna 1810).

In the eNB 1800 shown in FIG. 9, the transceiving unit 510 of the electronic device 500 described with reference to FIG. 5 may be implemented by a wireless communication interface 1825 (optionally, together with an antenna 1810). The determining unit 520 and the offload unit 530 of the electronic device 500 may be implemented by the controller 1821 (optionally, together with the wireless communication interface 1825 and the antenna 1810).

### Second Application Example

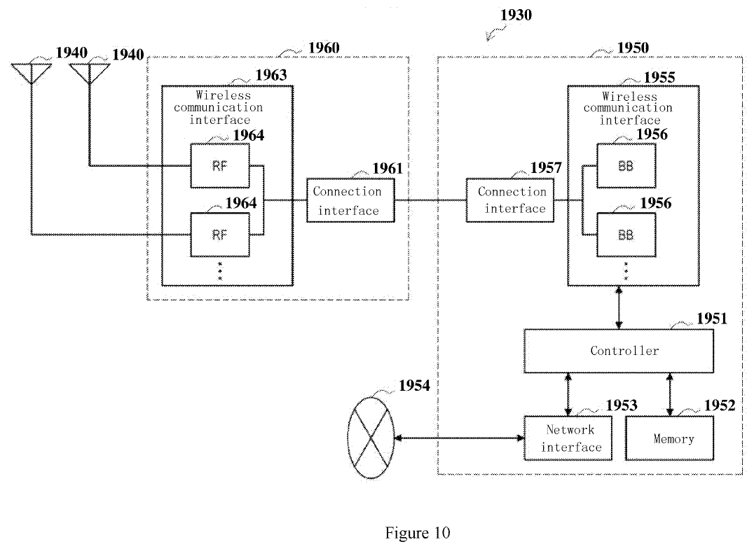

FIG. 10 is a block diagram showing a second example of a schematic configuration of an eNB to which the technology according to the present disclosure may be applied. An eNB 1930 includes one or more antennas 1940, a base station device 1950 and an RRH 1960. Each antenna 1940 and the RRH 1960 may be connected to each other via an RF cable. The base station device 1950 and the RRH 1960 may be connected to each other via a high-rate line such as a fiber cable.

Each of the antennas 1940 includes one or more antenna elements (such as the multiple antenna elements included in the MIMO antenna), and is used for transmitting and receiving the radio signal by the RRH 1960. As shown in FIG. 10, the eNB 1930 may include multiple antennas 1940. For example, the multiple antennas 1940 may be compatible with multiple frequency bands used by the eNB 1930. Although an example in which the eNB 1930 includes multiple antennas 1940 is shown in FIG. 10, the eNB 1930 may also include a single antenna 1940.

The base station device 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 described with reference to FIG. 9. The network interface 1953 is configured to connect the base station device 1950 to a core network 1954.

The wireless communication interface 1955 supports any cellular communication solution (such as LTE and LTE-advanced), and provides wireless communication with a terminal located in a sector corresponding to the RRH 1960 via the RRH 1960 and the antenna 1940. The wireless communication interface 1955 may typically include, for example, a BB processor 1956. Other than connecting to an RF circuit 1964 of the RRH 1960 via the connection interface 1957, the BB processor 1956 is the same as the BB processor 1826 described with reference to FIG. 9. As show in FIG. 10, the wireless communication interface 1955 may include multiple BB processors 1956. For example, the multiple BB processors 1956 may be compatible with the multiple frequency bands used by the eNB 1930. Although FIG. 10 illustrates an example in which the wireless communication interface 1955 includes multiple BB processors 1956, the wireless communication interface 1955 may also include a single BB processor 1956.

The connection interface 1957 is an interface for connecting the base station device 1950 (the wireless communication interface 1955) to the RRH 1960. The connection interface 1957 may also be a communication module for communication in the above-described high-rate line that connects the base station device 1950 (the wireless communication interface 1955) to the RRH 1960.

The RRH 1960 includes a connection interface 1961 and a wireless communication interface 1963.

The connection interface 1961 is an interface for connecting the RRH 1960 (the wireless communication interface 1963) to the base station device 1950. The connection interface 1961 may also be a communication module for the communication in the above high-rate line.

The wireless communication interface 1963 transmits and receives a radio signal via the antenna 1940. The wireless communication interface 1963 may generally include, for example, the RF circuit 1964. The RF circuit 1964 may include, for example, a frequency mixer, a filter and an amplifier, and transmit and receive a radio signal via the antenna 1940. The wireless communication interface 1963 may include multiple RF circuits 1964, as shown in FIG. 10. For example, the multiple RF circuits 1964 may support multiple antenna elements. Although FIG. 10 illustrates the example in which the wireless communication interface 1963 includes the multiple RF circuits 1964, the wireless communication interface 1963 may also include a single RF circuit 1964.

In the eNB 1930 shown in FIG. 10, the transceiving unit 230 of the electronic device 200 described with reference to FIG. 2 may be implemented by a wireless communication interface 1963 (optionally, together with an antenna 1940). The determining unit 210 and the offload unit 220 of the electronic device 200 may be implemented by the controller 1951 (optionally, together with the wireless communication interface 1963 and the antenna 1940).

In the eNB 1930 shown in FIG. 10, the transceiving unit 510 of the electronic device 500 described with reference to FIG. 5 may be implemented by a wireless communication interface 1963 (optionally, together with an antenna 1940). The determining unit 520 and the offload unit 530 of the electronic device 500 may be implemented by the controller 1951 (optionally, together with the wireless communication interface 1963 and the antenna 1940).

Preferred embodiments of the disclosure have been described above with reference to the drawings, but the disclosure is not limited to the above examples of course. Those skilled in the art may make various changes and modifications within the scope of the appended claims, and it is to be understood that such changes and modifications naturally fall within the technical scope of the present disclosure.

For example, units shown by a dotted line block in the functional block diagram shown in the drawings indicate that the functional units are optional in the corresponding device, and the optional functional units may be combined appropriately to achieve the required function.

For example, multiple functions of one unit in the above embodiment may be realized by separate devices. Alternatively, multiple functions implemented by multiple units in the above embodiments may be respectively implemented by separate devices. Furthermore, one of the above functions may be implemented by multiple units. Needless to say, such configurations are included in the technical scope of the present disclosure.

In the specification, steps described in the flowchart include not only the processing performed chronologically, but also the processing performed in parallel or individually rather than chronologically. Further, even in the steps processed chronically, without saying, the order may be appropriately changed.

The embodiments of the present disclosure are described in detail in conjunction with the drawings above. However, it should be understood that the embodiments described above are intended to illustrate the present disclosure rather than limit the present disclosure. Those skilled in the art may make various changes and modifications to the embodiments without departing from the essence and scope of the present disclosure. Therefore, the scope of the present disclosure is defined by the attached claims and equivalents thereof.

1. An electronic device, comprising:
processing circuitry, configured to:
determine whether uplink transmission of an integrated access and backhaul (IAB) node satisfies a long term congestion condition;
send an offload request to an IAB donor node when it is determined that the long term congestion condition is satisfied; and
perform data offloading on an egress link of the uplink transmission of the IAB node according to offload permission information from the IAB donor node.

2. The electronic device according to claim 1, wherein
the IAB node supports dual connectivity and has a first parent node and a second parent node; and
the data offloading comprises transmitting data of the uplink transmission of the IAB node through a main transmission path via the first parent node and an auxiliary transmission path via the second parent node.

3. The electronic device according to claim 2, wherein the offload request comprises information for indicating a transmission rate at which the IAB node expects to perform uplink transmission through the auxiliary transmission path.

4. The electronic device according to claim 2, wherein the processing circuitry is configured to perform the data offloading according to offload configuration information from the IAB donor node.

5. The electronic device according to claim 4, wherein the offload configuration information comprises one or more of:
offload ratio information for indicating a ratio between a data amount of uplink transmission performed by the IAB node through the main transmission path and a data amount of uplink transmission performed by the IAB node through the auxiliary transmission path;
offload rate information for indicating a maximum transmission rate at which the IAB node performs uplink transmission through the auxiliary transmission path; and
offload data amount information for indicating a maximum transmission data amount of uplink transmission performed by the IAB node through the auxiliary transmission path.

6. The electronic device according to claim 1, wherein the long term congestion condition comprises:
a duration in which a first congestion standard is satisfied is greater than or equal to a first predetermined time period; or
the number of times for which a second congestion standard is satisfied in a second predetermined time period is greater than or equal to a predetermined number of times, wherein the second congestion standard indicates more severe congestion than the first congestion standard.

7. The electronic device according to claim 6, wherein the first congestion standard and/or the second congestion standard is related to a load condition of the uplink transmission of the IAB node and/or a link quality of the egress link of the uplink transmission of the IAB node.

8. An electronic device, comprising:
processing circuitry, configured to:
receive an offload request from an integrated access and backhaul (IAB) node, wherein the offload request is sent when uplink transmission of the IAB node satisfies a long term congestion condition;
determine, in response to the offload request, whether to permit the IAB node to perform data offloading on an egress link of the uplink transmission of the IAB node; and
send offload permission information to the IAB node based on a result of the determining.

9. The electronic device according to claim 8, wherein
the IAB node supports dual connectivity and has a first parent node and a second parent node; and
the data offloading comprises transmitting data of the uplink transmission of the IAB node through a main transmission path via the first parent node and an auxiliary transmission path via the second parent node.

10. The electronic device according to claim 9, wherein the offload request comprises information for indicating a transmission rate at which the IAB node expects to perform uplink transmission through the auxiliary transmission path.

11. The electronic device according to claim 9, wherein the processing circuitry is further configured to: obtain, in response to the offload request, path condition information of the auxiliary transmission path from the second parent node.

12. The electronic device according to claim 11, wherein the path condition information indicates a load condition of the second parent node and/or a link quality of an access link from the IAB node to the second parent node.

13. The electronic device according to claim 11, wherein the processing circuitry is further configured to determine whether to permit the data offloading based on the path condition information.

14. The electronic device according to claim 9, wherein the processing circuitry is further configured to: provide offload configuration information for the IAB node when it is determined to permit the data offloading.

15. The electronic device according to claim 14, wherein the offload configuration information comprises one or more of:
offload ratio information for indicating a ratio between a data amount of uplink transmission performed by the IAB node through the main transmission path and a data amount of uplink transmission performed by the IAB node through the auxiliary transmission path;
offload rate information for indicating a maximum transmission rate at which the IAB node performs uplink transmission through the auxiliary transmission path; and
offload data amount information for indicating a maximum transmission data amount of uplink transmission performed by the IAB node through the auxiliary transmission path.

16. The electronic device according to claim 8, wherein the long term congestion condition comprises:
a duration in which a first congestion standard is satisfied is greater than or equal to a first predetermined time period; or
the number of times for which a second congestion standard is satisfied in a second predetermined time period is greater than or equal to a predetermined number of times, wherein the second congestion standard indicates more severe congestion than the first congestion standard.

17. The electronic device according to claim 16, wherein the first congestion standard and/or the second congestion standard is related to a load condition of the uplink transmission of the IAB node and/or a link quality of the egress link of the uplink transmission of the IAB node.

18. A wireless communication method, comprising:
determining whether uplink transmission of an integrated access and backhaul (IAB) node satisfies a long term congestion condition;
sending an offload request to an IAB donor node when it is determined that the long term congestion condition is satisfied; and
performing data offloading on an egress link of the uplink transmission of the IAB node according to offload permission information from the IAB donor node.

19. A wireless communication method, comprising:
receiving an offload request from an integrated access and backhaul (IAB) node, wherein the offload request is sent when uplink transmission of the IAB node satisfies a long term congestion condition;
determining, in response to the offload request, whether to permit the IAB node to perform data offloading on an egress link of the uplink transmission of the IAB node; and
sending offload permission information to the LAB node based on a result of the determining.

20. A non-transitory computer-readable storage medium having executable instructions stored thereon, wherein the executable instructions, when being executed by a processor, cause the processor to perform the wireless communication method according to claim 18.
